(19) United States
(12) Patent Application Publication
(10) Pub. No.: US 2007/0018621 A1
(43) Pub. Date: Jan. 25, 2007

(54) Area-Efficient Capacitor-Free Low-Dropout Regulator

(75) Inventors: Kwok Tai Philip Mok, Clear Water Bay (HK); Sai Kit Lau, Tseung Kwan O (HK); Ka Nang Leung, Tokwawan (HK)

Correspondence Address: PARSONS HSUE & DE RUNTZ LLP, 595 MARKET STREET, SUITE 1900, SAN FRANCISCO, CA, 94105, US

(73) Assignee: The Hong Kong University of Science and Technology, Clear Water Bay (HK)

(21) Appl. No.: 11/457,411

(22) Filed: Jul. 13, 2006

Related U.S. Application Data
(60) Provisional application No. 60/701,373, filed on Jul. 22, 2005.

(51) Int. Cl. G05F 1/00

(52) U.S. Cl. 323/280

(57) ABSTRACT

An area-efficient capacitor-free low-dropout regulator based on a current-feedback frequency compensation technique is disclosed. An implementation of a current feedback block with a single compensation capacitor is used to enable capacitance reduction. The resultant low-dropout regulator does not generally require an off-chip capacitor for stability and is particularly useful for system-on-chip applications.

### CROSS-REFERENCE TO RELATED APPLICATION

This application claims the benefit of U.S. Provisional Application No. 60/701,373, filed Jul. 22, 2005, entitled “Chip-Area-Efficient Capacitor-Free Low-Dropout Regulator,” which application is incorporated in its entirety by reference as if fully set forth herein.

### FIELD OF THE INVENTION

This invention relates to frequency compensation technique for low-voltage capacitor-free low-dropout regulators, in particular to such regulators which do not require an off-chip capacitor for stability, and to low-dropout regulators or amplifiers incorporating such techniques.

### BACKGROUND OF THE INVENTION

Conventionally, an off-chip output capacitor is required for achieving low-dropout regulator (LDO) stability, as well as good line and load regulations. However, the off-chip capacitor is the main obstacle to fully integrating the LDO in system-on-chip (SoC) applications. With the recent rapid development of SoC designs, there is a growing trend towards the integration of integrated circuits systems and power-management circuits. Local, on-chip and capacitor-free LDO regulators are important for future SoC applications. The capacitor-free feature significantly reduces system cost and board space, and also simplifies system design since external off-chip capacitor is eliminated.

Generally, for high-precision applications, a high low-frequency gain of the LDO regulators is required. A particular problem is that as the power supply voltage is scaled down in the current trends, the threshold voltage is not necessarily scaled down in the same way. At low supply voltages, cascode topology is no longer suitable for achieving high low-frequency gain. Instead, multi-stage approach is widely used by cascading several stages horizontally. However, the stability and the bandwidth of the LDO regulators with cascaded approach are both limited by the existing frequency compensation techniques. Currently, due to the stability issue, state-of-the-art capacitor-free LDO regulators need a minimum load current, typically around 10 mA, to be stable under normal operation. However, this minimum load current requirement is a major obstacle to applying capacitor-free LDO regulators in system-on-chip applications.

### PRIOR ART

Frequency compensation techniques for LDO regulators with cascaded approach are increasingly demanded in low-voltage designs. One very well known prior frequency compensation technique is nested Miller-based compensation which is commonly used to ensure the stability of a LDO regulator with multi-stage approach. FIG. 1 shows schematically the structure of a three-stage nested Miller-based LDO regulator. The LDO regulator of FIG. 1 suffers from stability problems especially when the load current is below several milli-amperes. As shown in FIG. 2, when the load current is around several milliampere ranges, the second and third pole will cause a magnitude peak near the unity-gain frequency due to the small value of the damping factor of the second order function of the second and third poles of the LDO regulator. One possible solution to extend the minimum load current is to use a large compensation capacitor Cₘₗ. However, this is not an effective solution as the frequency response and transient performance are sacrificed. In addition, both chip area and cost are increased significantly.

### SUMMARY OF THE INVENTION

According to the present invention, there is provided a three-stage capacitor-free low-dropout regulator comprising: first, second and third gain stages wherein said first gain stage having a differential input stage and a single-ended output, a high-swing second gain stage with input connecting to the output of the first stage and a single-ended output, a power PMOS transistor as the third gain stage with gate terminal connecting to the output of the second stage, source terminal connecting to the input voltage, and drain terminal connecting to the output of the regulator. A capacitor is connected between the output of the first stage and the output of the regulator while a voltage reference is connected to the negative of the error amplifier. A current feedback block is for feeding back a small-signal current that is proportional to the time derivative of the output voltage of the second stage to the output of the first stage. It can control the damping factor of the second and third complex poles of the said regulator so as to improve the stability of the regulator without using a large compensation capacitor Cₘₗ and sacrificing the performance.

The regulator may preferably be provided with a feedforward transconductance stage extending from the output of the first stage to the output of the regulator to further improve both frequency and dynamic responses.

### BRIEF DESCRIPTION OF THE DRAWINGS

An embodiment of the invention will now be described by way of example and with reference to the accompanying drawings, in which:

FIG. 1 is a schematic circuit diagram illustrating a frequency compensation technique according to the prior art,

FIG. 2 is a Bode plot of capacitor-free LDO regulator constructed in accordance with the prior art of FIG. 1 at low and moderate current,

FIG. 3A is a schematic circuit diagram illustrating the structure of the capacitor-free LDO regulator according to an embodiment of the present invention,

FIG. 3B is an alternative schematic of the circuit of FIG. 3A with a feed-forward stage in a different configuration.

FIG. 3C shows the current feedback block of FIG. 3A connected between two nodes of the circuit.

FIG. 3D shows a more detailed view of one embodiment of the current-feedback block of FIG. 3C.

FIG. 4 is a detailed circuit diagram showing one possible implementation of the embodiment of FIG. 3A,

FIG. 5 is a plot showing the transient response of the capacitor-free LDO regulator of FIG. 4 from 100 mA to 100 μA when driving a 100 pF capacitive load,

FIG. 6 is a plot showing the transient response of the capacitor-free LDO regulator of FIG. 4 from 100 μA to 100 mA when driving a 100 pF capacitive load,

FIG. 7 is a circuit diagram showing a second embodiment of the invention, and

FIG. 8 is a circuit diagram showing a third embodiment of the invention.

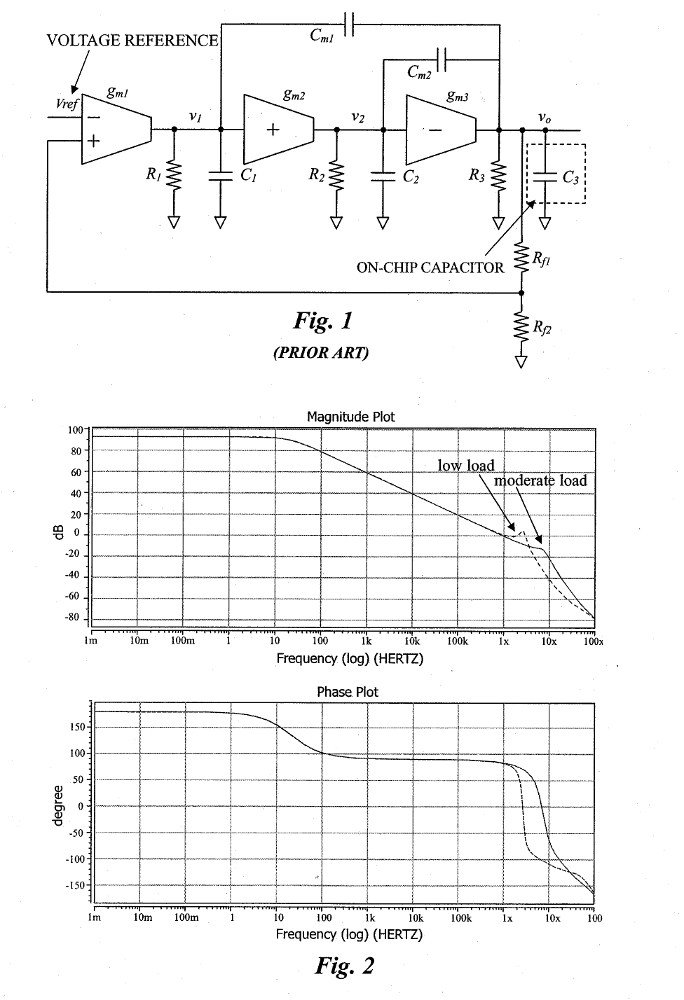

### DETAILED DESCRIPTION OF PREFERRED EMBODIMENT

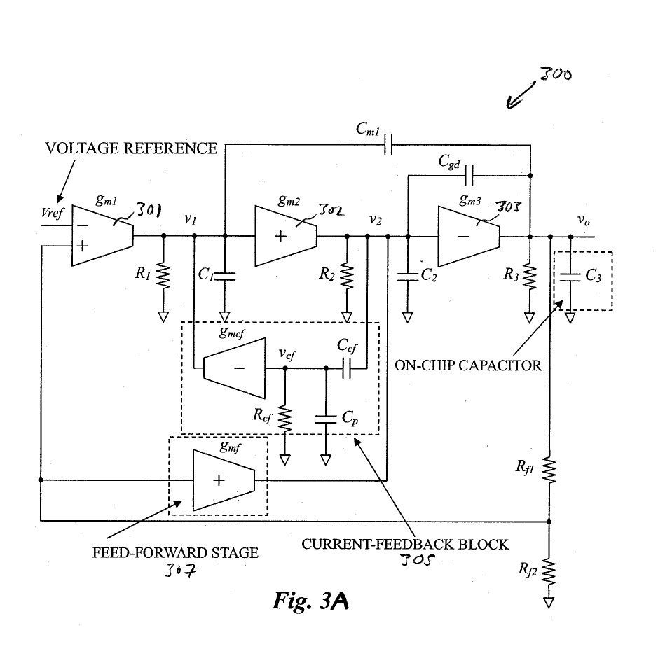

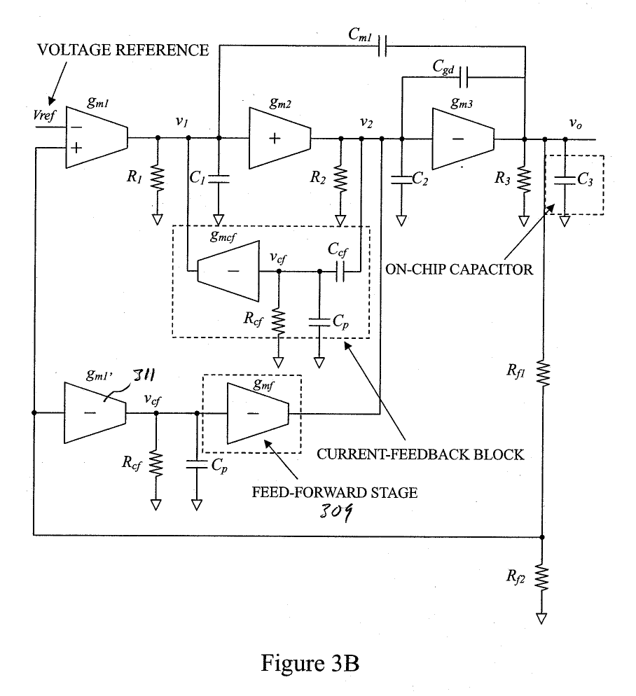

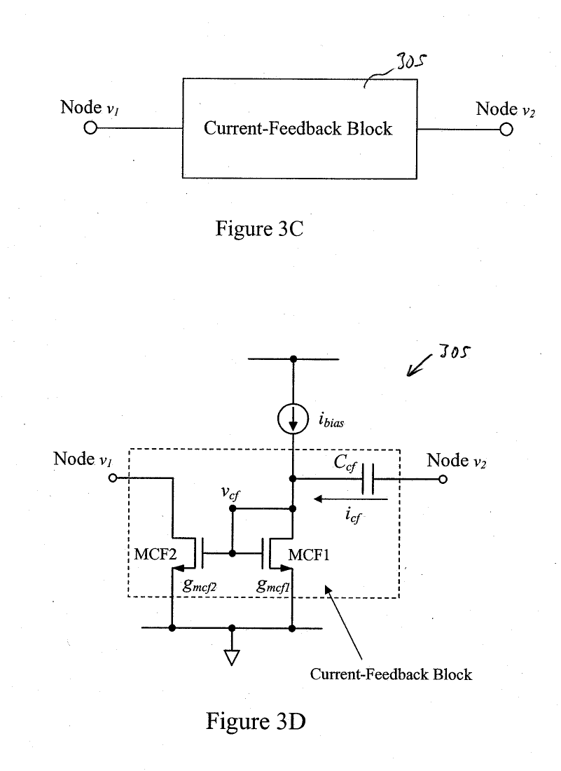

Referring to FIG. 3A there is shown schematically the structure of a capacitor-free low-dropout regulator 300 according to a preferred embodiment of the invention. The capacitor-free LDO regulator comprises of three gain stages. The first gain stage 301 is a high-gain error amplifier having a differential input and single-ended output gain stage with transconductance gₘ₁, where the inverting terminal is connected to the output of the voltage reference while the non-inverting terminal is connected to a feedback resistor R_{f1}, and has an output resistance R₁ and a parasitic capacitance C₁. A second stage 302 receives the output signal of the first stage 301 and is a positive gain stage with transconductance gₘ₂, output resistance R₂ and parasitic capacitance C₂. A third gain stage 303 receives the output signal of second stage 302 and is a negative gain stage with transconductance gₘ₃ and output resistance R₃. In addition, C₃ is the on-chip capacitance.

As there are three gain stages, a high low-frequency loop gain is achieved which provides good line and load regulations and therefore, high-precision output voltage is obtained. However, there are three high-impedance nodes and hence three low-frequency poles are associated with the capacitor-free LDO 300. The said LDO 300 is potentially unstable, especially at the low load current condition. Therefore, an advanced frequency compensation technique is required to stabilize the capacitor-free LDO 300.

The stability of LDO 300 is illustrated In FIG. 3A is achieved by using an extra current-feedback block 305 with a compensation capacitor C_{cf} which is connected between the output of first stage 301 and the output of second stage 302. current-feedback block 305 has a negative gain stage with transconductance of g_{mcf}. The compensation capacitor C_{cf} feeds back the small-signal current proportional to the time derivative of the output of second stage 302 to the node v_{cf} with an input resistance R_{cf} and a parasitic capacitance Cₚ. The transconductance cell −g_{mcf} senses the small-signal voltage at the node v_{cf} and generates a small-signal current to the output of first stage 301. This current-feedback block encloses a negative feedback around the loop with the −g_{mcf} and gₘ₂ transconductance stages. This negative feedback loop improves the frequency response performance of the capacitive-free LDO 300. An additional compensation capacitor Cₘ₁ is connected between the output of first stage 301 and the output of the capacitive-free LDO 300. At low and moderate load current ranges, compared with the conventional design in FIG. 1, the quality factor of the circuit in FIG. 3A is decreased. This means the effect of the magnitude peaking will be smaller for the same loading currents. Moreover, quality factor will be further reduced by decreasing the compensation capacitor Cₘ₁. In other words, having the same minimum loading current value for SoC applications, the required compensation capacitor Cₘ₁ of the circuit in FIG. 3A will be smaller and therefore higher unity-gain-frequency and faster load transient response are achieved. In addition, the chip area and costs are much reduced as large compensation capacitor Cₘ₁ is not required.

FIG. 3B shows an alternative schematic to that of FIG. 3A where feedforward stage 309 is not directly coupled to the input of first stage 301, but instead is connected through a gain stage 311 having a transconductance gm1′. In some cases, transconductance stage gm1 and gm1′ are implemented together so that they share certain components.

FIG. 3C shows a current-feedback block 305 that is connected between two nodes of the circuit of FIG. 3A.

FIG. 3D shows a circuit diagram of one implementation of current feedback block 305 of FIG. 3C. Current feedback block 305 includes two transistors MCF1 and MCF2, having their gates connected together. Transistor MCF1 is in a diode connected configuration and receives a bias current i_{bias} and a current input i_{cf} from node v2. The current feedback block acts as a current buffer that tends to produce a current through transistor MCF2 that is equal to that through transistor MCF 1.

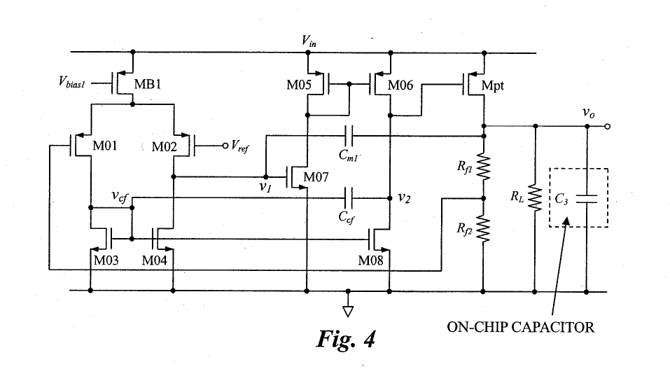

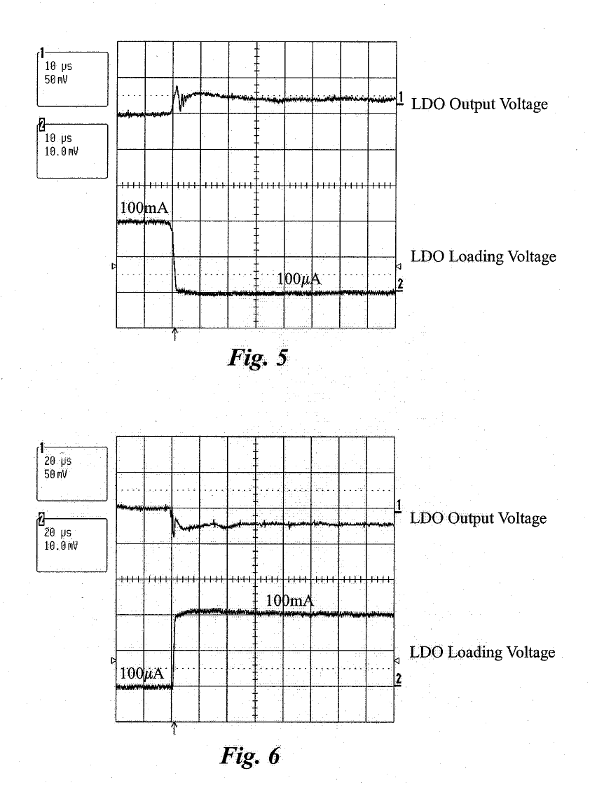

FIG. 4 is a detailed circuit implementation at transistors level of one possible realization of the capacitive-free LDO according to the embodiment of the invention as shown in FIG. 3A. The capacitive-free LDO in accordance with this embodiment of invention has been fabricated using CMOS technology. In the embodiment of FIG. 4, the current feedback block shares certain devices with the first gain stage. For example, transistors M03 and M04 may be considered to be shared between the first gain stage and the current feedback block. This is an alternative arrangement to that of FIG. 3D which shows a current feedback block that does not share devices. Also, the feed-forward stage of FIG. 4 shares certain devices with the first stage. For example, M01 and M03 may be considered to be shared. The measured load transient responses from 100 μA to 100 mA and from 100 mA to 100 μA with 100 pF capacitive load are shown in FIG. 5 and FIG. 6, respectively. FIG. 5 shows the effect of a drop in the load current from 100 mA to 100 uA. The lower trace shows the change in current, while the upper trace shows the small change in output voltage. FIG. 6 shows the effect of an increase in the load current from 100 uA to 100 mA. The lower trace shows the change in current while the upper trace shows the small change in output voltage. From the measurement results, the capacitive-free LDO in accordance with this embodiment of invention is absolutely stable for the load current down to hundred microamperes. This shows the LDO in accordance with this embodiment of invention is highly suitable for SoC applications as the minimum load current restrictions are greatly improved.

As the parasitic capacitor at the gate of the power pass transistor is usually large, a feedforward transconductance gain stage with a transconductance g_{mf} is implemented to form a class-AB push-pull gain stage. This can improve both the frequency response and eliminate slew-rate limitation. The feedforward transconductance stage is implemented by the transistor M08, as shown in FIG. 4.

For SoC designs, the loading capacitor is assumed to be the capacitance coming from the power lines. Under this circumstance, the equivalent series resistance does not exist. Moreover, the power PMOS pass transistor is designed to operate in linear region at the minimum supply voltage and maximum loading current. Thus, the required pass transistor size can be significantly reduced for ease of integration and cost reduction.

In order to provide a clearer insight to the proposed structure and without losing accuracy, the following assumptions are made to simplify the transfer function.

1) C₁, C₂, Cₚ and C_{gd} are the parasitic capacitors (where C_{gd} is the parasitic gate-to-drain capacitor of the power pass transistor).

2) The resistance at the current feedback node v_{cf} is equal to the reciprocal of its transconductance (i.e. R_{cf}=1/g_{mcf}).

3) The gain of each stage is much greater than one.

4) Cₘ₁ and C_{cf} are the compensation capacitors.

With these assumptions, the small-signal voltage gain transfer function of the capacitive-free LDO regulator in FIG. 3A is given by:

$$\frac{- {g}_{m 1} {g}_{m 2} {g}_{m 3} {R}_{1} {R}_{2} {R}_{3} ( 1 + \frac{{sC}_{m 1} {g}_{mf 1}}{{g}_{m 1} {g}_{m 2}} ) ( \frac{{R}_{f 2}}{{R}_{f 1} + {R}_{f 2}} )}{\begin{matrix}( 1 + {sC}_{m 1} {g}_{m 2} {g}_{m 3} {R}_{1} {R}_{2} {R}_{3} ) \times \\ [ \begin{matrix}1 + s \frac{{C}_{m 1} {C}_{gd} ( {g}_{m 3} - {g}_{m 2} ) + {C}_{cf} {C}_{3} {g}_{m 2} + {C}_{m 1} {C}_{cf} {g}_{m 2} {g}_{m 3} {R}_{cf}}{{C}_{m 1} {g}_{m 2} {g}_{m 3}} + \\ {s}^{2} \frac{( {C}_{gd} + {C}_{2} + {C}_{cf} ) {C}_{3}}{{g}_{m 2} {g}_{m 3}}\end{matrix} ]\end{matrix}}$$

From the above equation, the feedforward stage g_{mf} removes the right-half-plane (RHP) zero and generates a left-half-plane (LHP) zero to provide a positive phase shift and compensate the negative phase shift of the non-dominant poles. This helps to improve the phase margin of the voltage regulator. From the circuit implementation point of view, the power consumption will not be increased with the feedforward transconductance stage while dynamic performance of the LDO is improved.

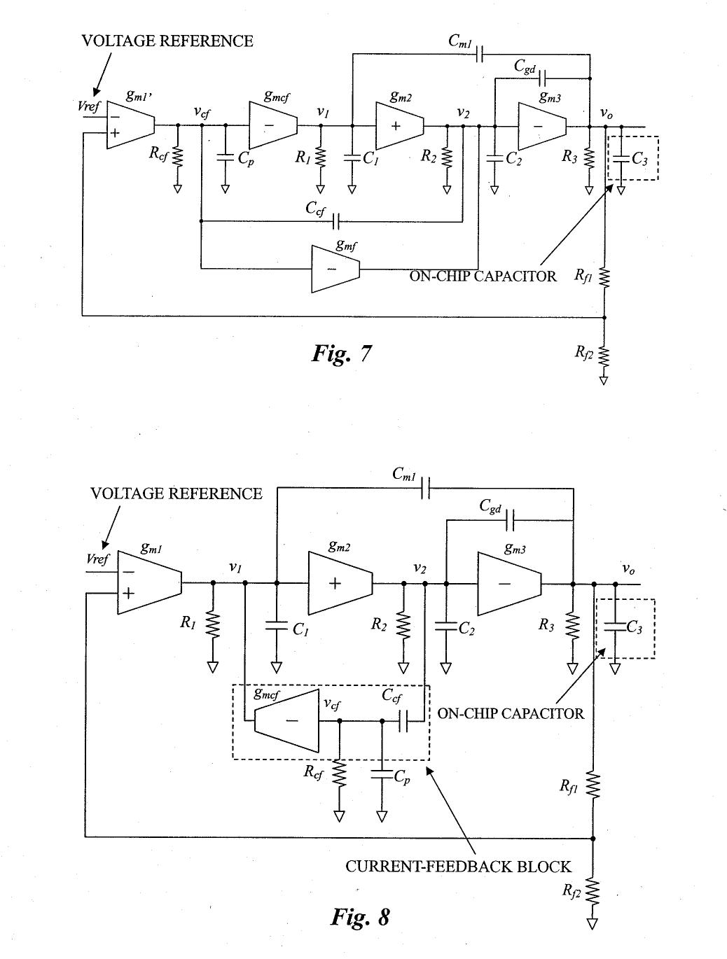

In the embodiment of FIG. 3A the capacitive-free low-dropout regulator is provided with a feedforward transconductance stage. An equivalent structure is shown in FIG. 7, in which the current buffer is embedded in the first stage. FIG. 3A and FIG. 7 may be considered to be two possible equivalent structures that each correspond to the circuit of FIG. 4. Thus, in some cases, part of the current feedback block may be considered to also be part of the first stage, while in others, it may be considered to be a separate component. While a feedforward transconductance stage is preferred, it is not essential and FIG. 8 shows schematically an embodiment similar to that of FIG. 3A but without the feedforward transconductance stage.

An example of the present invention has been described above but it will be understood that a number of variations may be made to the circuit design without departing from the spirit and scope of the present invention. At least in its preferred forms the present invention provides a significant departure from the prior art both conceptually and structurally. While a particular embodiment of the present invention has been described, it is understood that various alternatives, modifications and substitutions can be made without departing from the concept of the present invention. Moreover, the present invention is disclosed in CMOS implementation but the present invention is not limited to any particular integrated circuit technology and also discrete-component implementation.

What is claimed is:

1. A low-dropout regulator comprising:
a first amplifier stage having a first input, a second input and a first stage output, the first input connected to a reference voltage;
a positive-gain second amplifier stage having a second amplifier stage output and a second amplifier stage input that is connected to the first amplifier stage output;
a power PMOS transistor having a drain terminal connected to an output node, a gate terminal connected to the second amplifier stage output, and a source terminal connected to an input supply voltage;
a feedback resistor connected between the output node and the second input;
a compensation capacitor connected between the output of the first amplifier stage and the output node;
a current-feedback block feeding back a small-signal current output of the second amplifier stage to a node of the first amplifier stage.

2. The low-dropout regulator of claim 1 wherein the node of the first amplifier stage is the first amplifier stage output.

3. The low-dropout regulator of claim 1 wherein the node of the first amplifier stage is an internal node of the first amplifier stage.

4. The low-dropout regulator of claim 1 further comprising a feedforward transconductance stage having an input that is connected to the second input of the first amplifier stage and an output that is connected to the gate of the PMOS pass transistor

5. The low-dropout regulator of claim 1 wherein said power PMOS transistor operates in either linear or saturation modes.

6. The low-dropout regulator of claim 1 wherein said low-dropout regulator is stabilized without an off-chip capacitor.

7. The low-dropout regulator of claim 1 further comprising a fully integrated on-chip capacitor at the output of the low-dropout regulator.

8. The low-dropout regulator of claim 1 wherein said second amplifier stage is a high-swing positive-gain stage which is in common-source configuration.

9. The low-dropout regulator of claim 1 wherein said current-feedback block comprises a compensation capacitor and a current buffer, a terminal of the compensation capacitor is connected between the second amplifier stage output and an input of the current buffer, and an output of the current buffer is connected to the first amplifier stage output.

10. The low-dropout regulator of claim 1 wherein said current-feedback block comprises a compensation capacitor, the first amplifier stage is formed by a first cascade-connected negative gain circuit and a second cascade connected negative gain circuit, and the compensation capacitor is connected between the second amplifier stage output and a negative output of the first cascade-connected negative gain circuit.

11. The low-dropout regulator of claim 10 further comprising a feedforward transconductance stage connected between the output of the first cascade-connected negative gain circuit and the output of the second amplifier stage.

12. The low-dropout regulator of claim 10 further comprising a feedforward transconductance stage connected between the second input to the first stage and the second amplifier stage output.

13. The low-dropout regulator of claim 10 wherein said second cascade-connected negative gain stage comprises two active load transistors, one of said active load transistors is a diode-connected transistor whose drain terminal and gate terminal are connected together while the source terminal is connected to ground, and the other one of said active load transistors is in common-source configuration with its gate terminal connected to the gate terminal of the diode-connected transistor, its drain terminal connected to the output of the first stage and its source terminal connected to ground, and wherein a compensation capacitor is connected to the gate terminal of the diode-connected transistor.

14. The low-dropout regulator of claim 1 wherein said current-feedback block is a negative amplifier stage with a compensation capacitor, the current-feedback block connected between the first amplifier stage output and the second amplifier stage output.

15. The low-dropout regulator of claim 1 wherein said current-feedback block feeds back the small-signal current proportional to the time derivative of the output of the second amplifier stage to the output of the first amplifier stage.

16. The low-dropout regulator of claim 1 wherein said current-feedback block encloses a negative feedback loop around the current-feedback block and the second gain stage.

17. The low-dropout regulator of claim 1 further comprising a class-AB push-pull feedforward transconductance stage implemented at the gate terminal of the power PMOS transistor.

18. The low-dropout regulator of claim 1 wherein a parasitic drain-to-gate capacitor of the power PMOS transistor provides frequency compensation.

19. The low-dropout regulator of claim 1 wherein said voltage reference is a supply-independent and temperature-independent stable voltage that defines the output voltage of the capacitive-free low-dropout regulator.

20. The low-dropout regulator of claim 1 wherein said regulator is implemented in an integrated circuit.

21. The low-dropout regulator of claim 1 wherein said regulator is connected to an off-chip capacitance.

22. A low-dropout regulator comprising:
a first amplifier stage having a first input, a second input and an output connected to a first node, a voltage provided to the output by the first stage determined by a voltage difference between the first input and the second input, the first input provided with a reference voltage;
a second amplifier stage having an input connected to the first node and an output connected to a second node;
a third amplifier stage having an input connected to the second node and an output connected to a third node;
a feedback resistor connected between the third node and the second input a feedback capacitor connected between the first node and the third node;
a current feedback block having an input connected to the second node and an output connected to the first node; and
a feedforward transconductance stage having an input connected to the second input and having an output connected to the second node.

23. The regulator of claim 22 wherein the third amplifier stage comprises a power PMOS transistor having a drain terminal connected to the third node and a gate terminal connected to the second node.

24. The regulator of claim 22 wherein the current feedback block includes a current buffer and a capacitor.

25. A method of providing a stable output voltage, comprising:
providing a reference voltage to a first input of a first stage, the first stage providing a first output that is an amplifier function of the voltage difference between the first input and a second input;
providing the first output to a second stage that provides an amplified second output;
providing the second output to a third stage, the third stage providing a third output, the third stage including a power transistor connected between a supply voltage and the third output;
providing a first feedback signal from the third output to the second input, the first feedback signal passing through a resistor;
providing a second feedback signal from the third output to the first output, the second feedback signal passing through a capacitor; and
providing a third feedback signal to the first output, the third feedback signal generated from the second output

26. The method of claim 25 wherein the third feedback signal is generated by a capacitor and a negative gain stage connected in series between the third output and the first output.

27. The method of claim 25 further comprising providing a feed forward signal from the second input to the third stage.
